(19) United States
(12) Patent Application Publication
(10) Pub. No.: US 2014/0195327 A1
(43) Pub. Date: Jul. 10, 2014

(54) Mobile Communication and Coupon-Pushing System and Method

(71) Applicants: Jakub Tomasz Poskrobko, Aleksandrow Lodzki (PL); Sherri L. Jones, Hickory Creek, TX (US)

(72) Inventors: Jakub Tomasz Poskrobko, Aleksandrow Lodzki (PL); Sherri L. Jones, Hickory Creek, TX (US)

(73) Assignee: TEZHQ, INC., Lake Kiowa, TX (US)

(21) Appl. No.: 14/146,840

(22) Filed: Jan. 3, 2014

Related U.S. Application Data
(60) Provisional application No. 61/848,477, filed on Jan. 4, 2013.

(51) Int. Cl. G06Q 30/02; G06Q 50/12

(52) U.S. Cl. CPC G06Q 30/0267; G06Q 30/0239; G06Q 50/12
USPC 705/14.39; 705/14.58

(57) ABSTRACT

A system and method for providing discount coupons to a customer in a business establishment such as a restaurant. A control server associated with the business establishment is configured to communicate over a wireless communication link with a mobile telecomputing device, such as a smart phone, of the customer. The control server enables the customer to request services utilizing the customer's smart phone. The control server sends the discount coupons to the customer's mobile telecomputing device proactively or in response to customer or waiter requests.

### CROSS-REFERENCE TO RELATED APPLICATIONS

This application claims the priority benefit under 35 U.S.C §119(e) of U.S. Provisional Application No. 61/848,477 filed Jan. 4, 2013.

### BACKGROUND

1. Technical Field

This invention relates to communication systems and, more particularly, to a mobile communication and coupon-pushing system and method enabling a customer in a restaurant or other business establishment to utilize a personal smart phone or other mobile telecomputing device to communicate with a waiter or other service person and to receive coupons pushed to the phone or device by the restaurant or business establishment.

2. Description of Related Art

In some restaurants today, customers can push a button on a transmitter mounted on their table to request service from their waiter. The transmitter may be programmed to transmit a table number to a control PC, or to transmit an identifier that is then associated with a table number by the PC. The PC may also include a list of waiters assigned to each table number and a lookup table for identifying corresponding pager numbers for the waiters. An on-premises paging transmitter then pages the correct waiter to respond to the customer's request for service.

U.S. Patent Application Publication No. 2002/0147647 describes a system in which a local patron utilizes a touch screen terminal mounted at the patron's table. This terminal belongs to the restaurant and is not mobile. The patron can use the terminal to communicate through a maitre d′ system with a waiter carrying a communication device. A remote user can use a two-way interactive device such as a pager or web-enabled cell phone to dial into the maitre d′ system to place orders. However, the remote user does not bring the device to the restaurant and cannot use it to communicate with a waiter.

U.S. Patent Application Publication No. 2012/0209729 and U.S. Patent Application Publication No. 2013/0246299, which are co-owned by the Applicant of the present application, describe a system known as Waiter Locator®, a mobile application that uses location services to allow a customer in a retail establishment (restaurant, club, bar, etc.) to utilize a personal smart phone to browse a list of nearby establishments and select the one where the customer is currently located. The system allows customers to register themselves and to optionally provide certain demographic data (name, email address, birthday, zip code, sex, income level, and the like). After registering in a subscribing establishment such as a restaurant, for example, they can log in and use their mobile phone to call their waiter for drinks, the check, a manager, and so on.

### SUMMARY OF THE INVENTION

Restaurant managers look for ways to bring customers into the restaurant and to keep them coming back. Discount coupons play a role in this endeavor, and are generally available in newspapers, local magazines, and sometimes through the restaurant's website. Overall, however, the redemption rate for such coupons is quite low, with fewer than two percent of all issued coupons being redeemed.

It would be advantageous to have a restaurant communication system and method that combines the convenience of enabling a customer to communicate with a waiter using the customer's own phone with a coupon-pushing system that would increase the efficiency and effectiveness of the restaurant's coupon program. The present invention provides such a system and method.

In one embodiment, the present invention is directed to a computer-implemented method of providing discount coupons to a customer in a business establishment. The method includes communicably connecting a mobile telecomputing device of the customer to a control server associated with the business establishment; the control server providing at least one virtual service-request button on a display of the customer's mobile telecomputing device, wherein pressing the at least one virtual service-request button enables the customer to request services from the business establishment utilizing the customer's mobile telecomputing device; and pushing the discount coupons by the control server to the customer's mobile telecomputing device for display thereon.

In another embodiment, the present invention is directed to a system for providing discount coupons to a customer in a business establishment. The system includes a control server associated with the business establishment; and a wireless communication link for communicating between the control server and a mobile telecomputing device of the customer. The control server is configured to provide at least one virtual service-request button on a display of the customer's mobile telecomputing device, wherein pressing the at least one virtual service-request button enables the customer to request services from the business establishment utilizing the customer's mobile telecomputing device; and to push the discount coupons to the customer's mobile telecomputing device for display thereon.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 is a flow chart illustrating the steps of an exemplary embodiment of an overall method of the present invention;

FIGS. 2A-2B are portions of a flow chart illustrating the steps of a first exemplary embodiment of a method of providing the customer with the capability to utilize his personal mobile phone to communicate with the control server and make service requests;

FIG. 3 is a flow chart illustrating the steps of a second exemplary embodiment of a method of providing the customer with the capability to utilize his personal mobile phone to communicate with the restaurant management system and make service requests;

FIG. 4 is a flow chart illustrating the steps of a first exemplary embodiment of a method of pushing coupons to the customer's phone;

FIG. 5 is a flow chart illustrating the steps of additional alternative embodiments of the method of pushing coupons to the customer's phone; and

FIG. 6 is a simplified block diagram of a first exemplary embodiment of the system of the present invention.

### DETAILED DESCRIPTION OF EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures, components, and circuits have not been described in detail so as not to obscure the present invention. The invention may be implemented in hardware or in a combination of hardware and software. For example, one or more computers or processors may perform the steps of the method of the present invention when executing computer program instructions stored in one or more program memories. Additionally, individual components of the invention may include their own processor and memory for controlling their functions.

The present invention provides a solution in which the customer's mobile phone is used as a restaurant communication device (for example Waiter Locator), and a coupon-pushing system pushes coupons to the customer's phone for redemption. The coupons may be for instant redemption (for example to reward the customer for bringing in a large party) or the coupons may be for a discount for a future visit (to encourage the customer to return).

It should be noted that although the invention is described herein in terms of a customer's smart phone, the invention is applicable to any type of mobile computing device capable of making a WiFi connection and communicating through the WiFi connection. These devices may be referred to generically as mobile telecomputing devices. The present invention takes advantage of these capabilities of mobile telecomputing devices.

As noted above, U.S. Patent Application Publication No. 2012/0209729 and U.S. Patent Application Publication No. 2013/0246299 are co-owned by the Applicant of the present application and describe the Waiter Locator® (WL) system. The disclosures of U.S. Patent Application Publication No. 2012/0209729 and U.S. Patent Application Publication No. 2013/0246299 are incorporated herein in their entireties.

The system disclosed herein may push two types of “coupons” to the customer: coupons and rewards. Coupons are pushed to the customer's mobile device and function like ordinary coupons—they provide an incentive for the customer to come to the restaurant and/or to purchase specific items. A restaurant can give away coupons to anyone they choose (for example, their customers who visited them directly or customers from a list purchased from a marketing source).

Rewards may be pushed to customer accounts by waiters. For example, a customer may be drinking beers and the waitress wants to give them a “reward” such as “1 free beer when you buy 3 on your next visit”. She inputs this request on her waiter terminal, and the system pushes a reward to the customer's account (for the next visit).

The coupons and rewards may have expiration dates and may be transferable to others. The coupon/reward is like money in the customer's bank account: when a coupon/reward is transferred, the coupon/reward is deleted from the customer's account and it goes to someone else. Likewise, when the customer redeems a coupon/reward, it is immediately removed from their account.

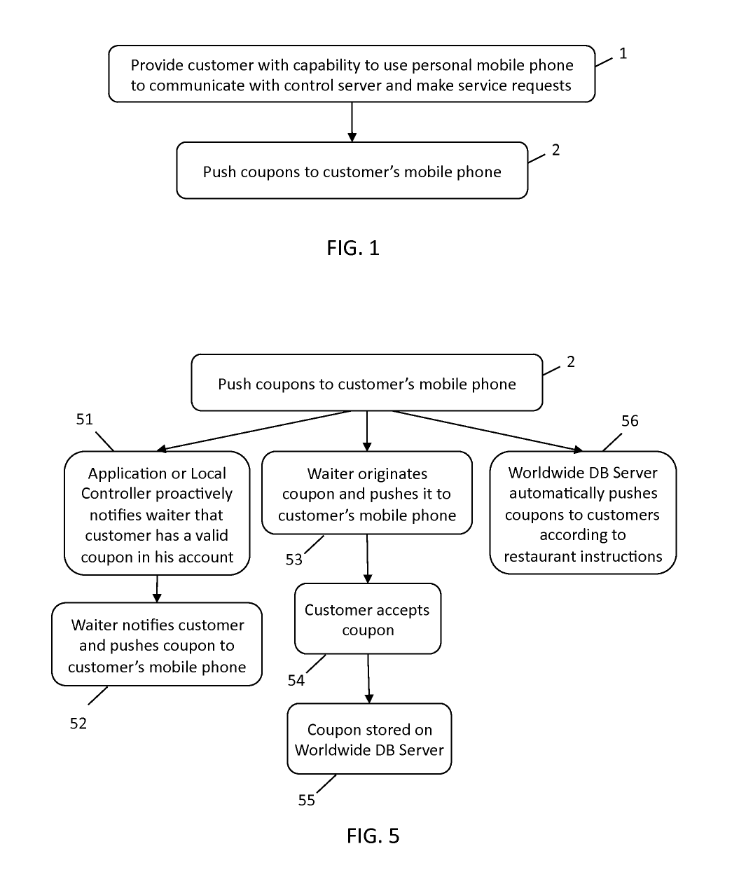

FIG. 1 is a flow chart illustrating the steps of an exemplary embodiment of an overall method of the present invention. At step 1, the customer is first provided with the capability to utilize his personal mobile phone to communicate with a control server and make service requests. This may be done with a system such as, for example, the WL system. At step 2, the control server, through either a mobile application or the restaurant's local intranet, then pushes coupons to the customer's phone.

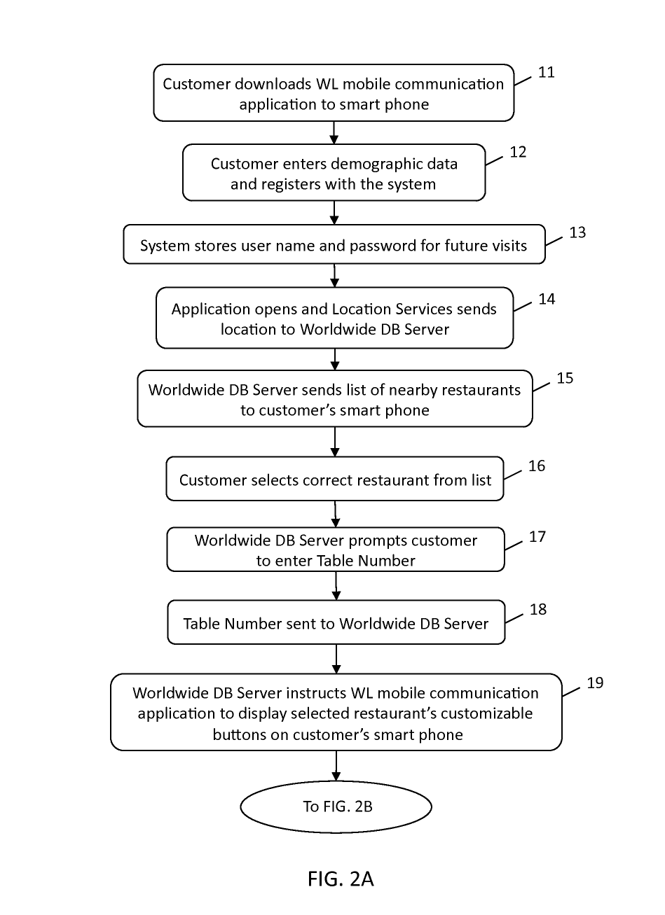

FIGS. 2A-2B are portions of a flow chart illustrating the steps of a first exemplary embodiment of a method of providing the customer with the capability to utilize his personal mobile phone to communicate with the control server and make service requests. As precursor events, the restaurant has been equipped with Wireless Fidelity (Wi-Fi) access points and an intranet with a connection to the Internet. The customer has been provided with a table identifier such as a table name or number and with instructions for downloading a WL mobile communication application to the customer's phone. At step 11, the customer connects his smart phone to the Internet through either the Public Land Mobile Network (PLMN) cellular network or through a Wi-Fi connection to the intranet in the restaurant and downloads the WL mobile communication application to the customer's smart phone. At step 12, the customer inputs his demographic data, and registers with the system. At step 13, the application may store a username and password for future visits. At step 14, the application opens and Location Services (using, for example, the General Packet Radio Service (GPRS), a Wi-Fi connection, or a Global Positioning System (GPS) location) sends coordinates of the mobile phone to a Worldwide Database (DB) Server via, for example, a GPRS data network. At step 15, the Worldwide DB Server pushes a list of restaurants close to this location to the customer's phone.

At step 16, the customer selects the correct restaurant from the list, and at step 17, the Worldwide DB Server prompts the customer to enter the Table Number, which may be shown, for example, on a card at the customer's table. At step 18, the table number is sent to the Worldwide DB Server, which instructs the WL mobile communication application at step 19 to display that particular restaurant's customizable virtual buttons on the customer's phone. The method then moves to FIG. 1B.

Referring to FIG. 2B, at step 20, the customer presses a displayed button to make a request, and the request is received at the Worldwide DB Server at step 21. At step 22, a Local Controller checks in with the Worldwide DB Server and obtains the request. At step 23, the Local Controller associates the request with a particular waiter assigned to the customer's table, and at step 24 notifies the waiter. The request may be displayed for the particular waiter on a waiter terminal. Alternatively or additionally, the Local Controller may page the particular waiter (for example through an on-premises paging system) and provide the request. At step 25, all data, response data, and the like are sent to the Worldwide DB Server for reporting.

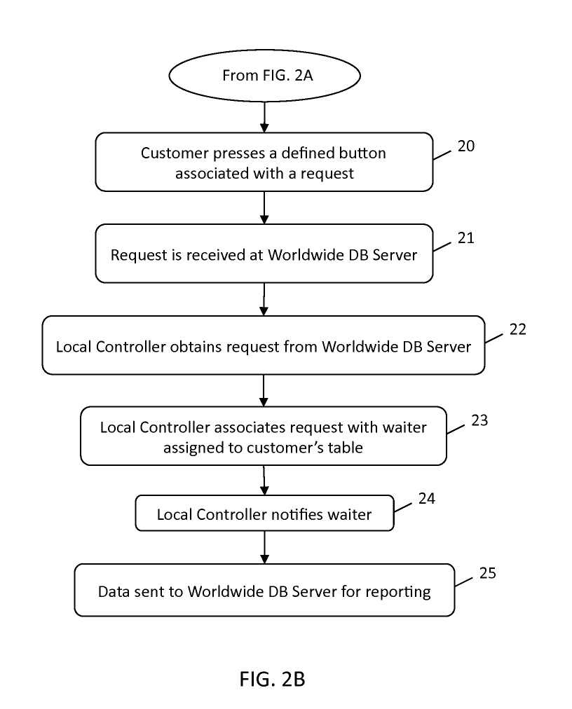

FIG. 3 is a flow chart illustrating the steps of a second exemplary embodiment of a method of providing the customer with the capability to utilize his personal mobile phone to communicate with the restaurant management system and make service requests. In this embodiment, no application is downloaded to the phone. Instead, a Wi-Fi connection is utilized to connect the customer's mobile phone to the restaurant's local intranet. As precursor events, the restaurant has been equipped with Wi-Fi access points and an intranet. The customer has been provided with a table identifier such as a table name or number and with instructions for browsing to an identified web page (for example, WL-1.com) using the customer's smart phone.

At step 31, the customer uses his phone to join the restaurant's intranet and browses to a given web page, which may be indicated on a sign on the customer's table. At step 32, the Wi-Fi Router sees the connection request, but a DNS table reroutes the phone to the local WL-1.com website hosted on the Local Controller. At step 33, the Local Controller pushes a web page with displayed virtual buttons to the customer's phone. The customer may be prompted and may enter demographic data and his table number at step 34. At step 35, the customer presses a displayed button (just like a webpage) to make a request. At step 36, the Local Controller receives the request and associates the request with a particular waiter assigned to the customer's table. At step 37, the Local Controller notifies the waiter. The request may be displayed for the particular waiter on a waiter terminal. Alternatively or additionally, the Local Controller may page the particular waiter (for example through an on-premises paging system) and provide the request. At step 38, all data, response data, and the like are sent to the Worldwide DB Server for reporting.

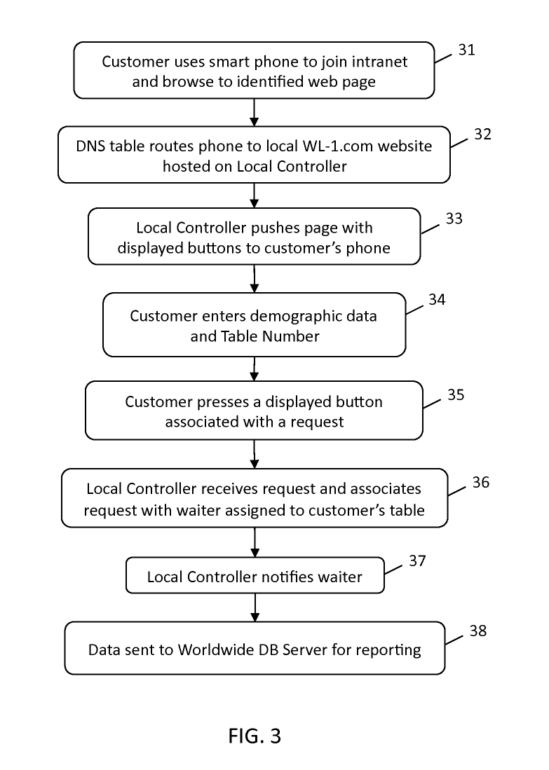

FIG. 4 is a flow chart illustrating the steps of a first exemplary embodiment of a method of pushing coupons to the customer's phone. Once the customer has established connectivity with the control server and is able to make service requests, the server may display virtual coupon-related buttons on the customer's mobile phone display at step 41. For example, the phone may display two buttons: a REQUEST COUPON button and a REDEEM COUPON button. When the customer pushes the REQUEST COUPON button at step 42, the method moves to step 43, where the application or Local Controller provides a list of various coupons offered by the restaurant where the customer is located. When the customer selects a coupon at step 44, the method moves to step 45, where the Worldwide DB Server saves the requested coupon to the user's account.

When the customer pushes the REDEEM COUPON button at step 46, the request is sent to the waiter for that table at step 47. The request may be sent to the waiter terminal (similar to a drink request) and/or the waiter may be paged. At step 48, the waiter looks at the customer's mobile phone display to determine what coupon has been requested, and chooses to either “Burn It” (i.e., redeem it) or “Deny It”. A request may be denied, for example, when there are prerequisite requirements for the discount, and the requirements have not been met. For example, the selected coupon may state, “Get 10% off on next visit within 30 days for buying >$100”. If the customer has not purchased more than $100 worth of food and drinks, the waiter may deny the request. In such a case, “Deny it” may merely cancel the redeem request so that the coupon stays in the customer's account for future use when the requirements are met.

Coupons may have a validity time period, for example, starting the following day and lasting 30 days. In the example case, if the customer purchases more than $100 on his current visit, he will get 10% off on a next visit within 30 days.

In one embodiment, the coupon may be associated with a particular retail company, restaurant chain, or corporation. Thus, a $10 off coupon can be used, for example, in any of the company's restaurants or stores.

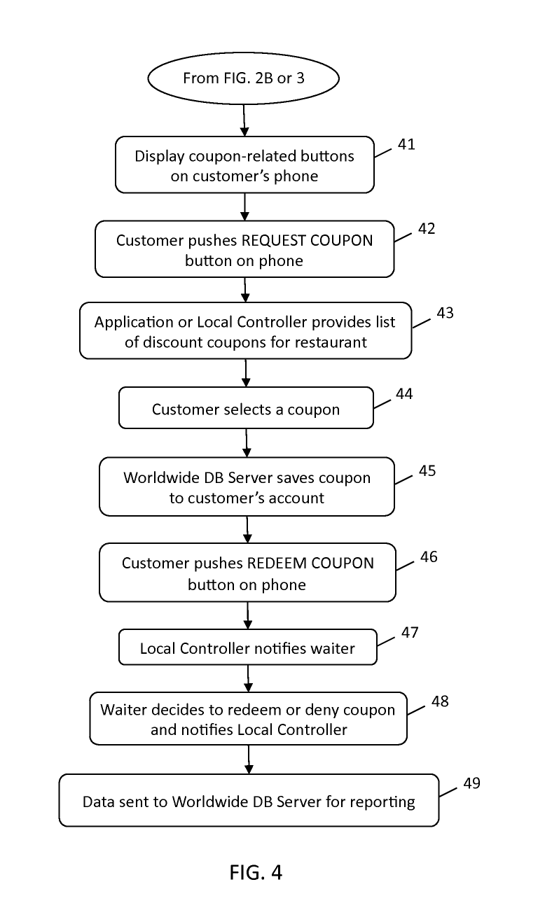

FIG. 5 is a flow chart illustrating the steps of additional alternative embodiments of the method of pushing coupons to the customer's phone, as in step 2 of FIG. 1. In one embodiment, at step 51, the WL application or Local Controller may proactively notify the waiter that the customer at a certain table (where the customer logged in) has a valid coupon in his account. So if the coupon states, “Buy 5-get 2 Free”, the waiter can notify the customer at step 52 and push the coupon to the customer's phone. This encourages the customer's party to buy more products in order to qualify for the coupon offer.

In another embodiment, at step 53, the waiter may originate and “Push” a coupon (for example, “Free appetizer on your next visit”) to a customer who is logged in at one of the waiter's tables. If the customer accepts the coupon at step 54, it is stored on the Worldwide DB Server at step 55. In another embodiment, customer acceptance is not required.

In another embodiment, at step 56, the Worldwide DB Server may automatically push coupons to customers according to restaurant instructions. For example, a restaurant may request the Worldwide DB Server to provide coupons to all the registered customers for $2 off a total bill or a particular item on next Thursday.

In another example, the restaurant may instruct that a coupon be issued if a customer completes a market research or customer satisfaction survey. Some companies pay money for market research surveys. At the bottom of the displayed page on the customer's mobile phone, the system may present a message such as “Take a survey and save $2 now” or “Take a survey and earn a free appetizer”. When the customer selects this option, the system may direct the mobile phone to a website for the survey. When the customer has registered his demographic data with the system, the survey can be customized and the results are highly desirable to the research company.

Completing the survey automatically earns a coupon for the particular user. The customer may request to redeem the coupon immediately, or during the next visit. For example, after the survey, the application may automatically notify the customer that the new “Take $2 off” coupon is released. Then the customer may request to redeem it. Pressing the REDEEM COUPON button sends an associated code to the waiter's terminal where he/she can deduct the amount from the bill and put in a validating code.

There are many retailers tackling the issues of copied coupons, expired coupons, and the like. By “burning” the coupon, it is redeemed and removed from the user's account. If the coupon goes past the assigned validation period, for example 30 days, it may be removed automatically. If the customer has provided demographic data, the system may enable the affected retailers to push-notify customers when coupons are approaching expiration dates.

In one embodiment, rather than dispensing coupons to all customers, the coupons are earned as rewards (for example through multiple visits) and must be validated. In this scenario, customers will typically ask for coupons from restaurants that they like. So when they receive push-notifications, the likelihood of the customer reacting to the coupon is much greater.

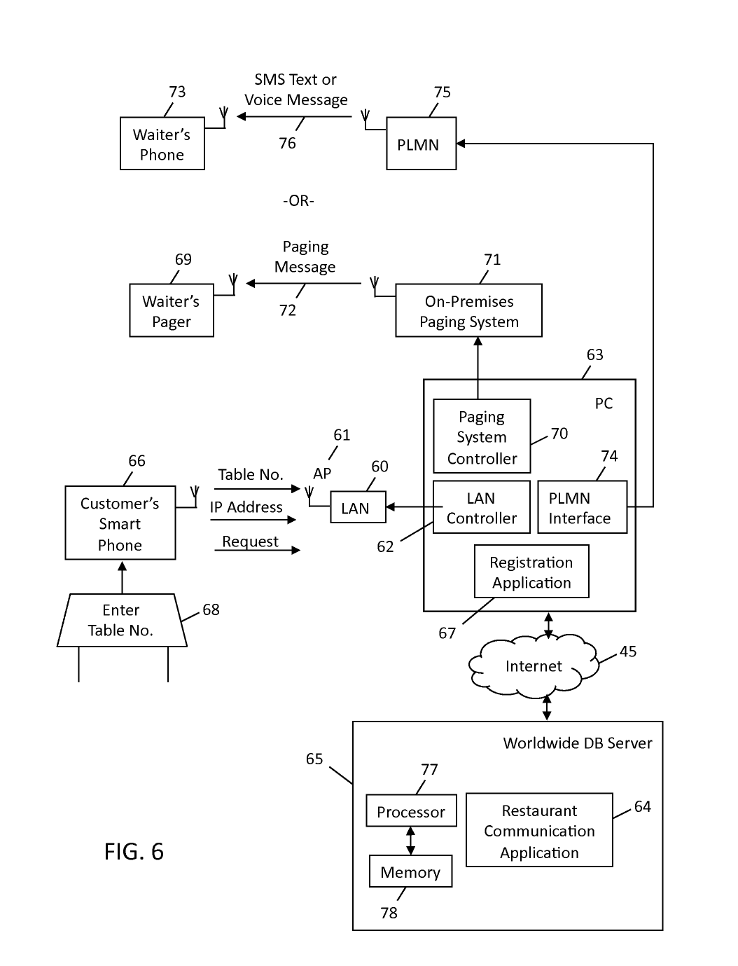

FIG. 6 is a simplified block diagram of a first exemplary embodiment of the system of the present invention. In this embodiment, a WiFi Local Area Network (LAN) 60 is set up with at least one Access Point/WiFi router (AP/router) 61 inside the restaurant. The network may be controlled, for example, by a LAN controller 62 in a PC 63 in a back office of the restaurant. The customer is provided with a table number and instructions for downloading a restaurant communication application 64 from the Worldwide DB Server 65 to the customer's smart phone 66. This information may be provided by a sign at each table or may be provided to the customer by a hostess or the waiter. The customer follows the instructions, registers with the system through a registration application 67 and connects to the WiFi network and downloads the application to the customer's smart phone.

The application gathers data from the back office PC 63 to define the functions of various buttons displayed to the customer on the phone's touch-screen display, or present on the phone's keyboard. When prompted by the application, the customer enters the table number 68. The customer can then use the smart phone to communicate with the waiter as further described below.

In an example scenario, a first button may be used to request a drink; another button may be used to request the customer's check; and another button may enable the customer to enter a text message with specific instructions for the waiter. When the customer presses one of the defined buttons, the communication application on the customer's phone sends a corresponding indication and the table number over the WiFi network 61 to the back office PC 63, which also controls communications with the waiter. In one embodiment, the waiter carries an on-premises pager 69, and a paging system controller 70 in the back office PC controls an on-premises paging system 71. The PC matches the table number with the waiter who is responsible for that table, and sends a command to the on-premises paging transmitter to send a paging message 72 to the waiter with the customer's table number and request. In an alternative embodiment, if the restaurant does not have an on-premises paging system, the waiter may carry a mobile phone 73 instead. In this embodiment, the back office PC includes a PLMN interface 74, which may place a call to the waiter's phone through the PLMN 75 with a recorded voice message or a Short Message Service (SMS) text message 76 indicating the table number and the customer's request. The waiter then responds to the customer's request.

All data from the request and response is sent to the Worldwide DB Server 65 for reporting. Operation of the Worldwide DB Server may be controlled by a processor 77 executing computer program instructions stored on a memory 78. Other components of the system may operate similarly with their own processors and memories. Coupons and rewards that are redeemed, transferred, or expired are automatically deleted from the customer's account.

It is thus believed that the operation and construction of the present invention will be apparent from the foregoing description. While the system and method shown and described has been characterized as being preferred, it will be readily apparent that various changes and modifications could be made therein without departing from the scope of the invention as defined in the following claims.

What is claimed is:

1. A computer-implemented method of providing discount coupons to a customer in a business establishment, the method comprising:
communicably connecting a mobile telecomputing device of the customer to a control server associated with the business establishment;
the control server providing at least one virtual service-request button on a display of the customer's mobile telecomputing device, wherein pressing the at least one virtual service-request button enables the customer to request services from the business establishment utilizing the customer's mobile telecomputing device; and
pushing the discount coupons by the control server to the customer's mobile telecomputing device for display thereon.

2. The method according to claim 1, wherein the business establishment is a restaurant, and the step of providing at least one virtual service-request button on a display of the customer's mobile telecomputing device includes providing a button that enables the customer to utilize the mobile telecomputing device to request service from a waiter.

3. The method according to claim 2, wherein the step of pushing the discount coupons to the customer's mobile telecomputing device includes proactively pushing the coupons to the mobile telecomputing device by the control server when the customer registers with the server.

4. The method according to claim 2, wherein the step of pushing the discount coupons to the customer's mobile telecomputing device includes proactively pushing the coupons to the mobile telecomputing device by the control server when the waiter requests the coupon.

5. The method according to claim 2, wherein the step of pushing the discount coupons to the customer's mobile telecomputing device includes pushing the coupons to the mobile telecomputing device by the control server in accordance with restaurant instructions.

6. The method according to claim 2, further comprising the control server providing a page for display on the mobile telecomputing device that includes virtual buttons for requesting or redeeming the coupons.

7. The method according to claim 6, further comprising:
detecting that the customer has pressed the button for requesting coupons;
send to the mobile telecomputing device, a list of available coupons page for the restaurant;
detecting that the customer has selected an available coupon; and
storing the selected coupon in an account for the customer.

8. The method according to claim 7, further comprising:
detecting that the customer has pressed the button for redeeming coupons;
the control server notifying the waiter that the customer desires to redeem the selected coupon stored in the customer's account;
receiving an indication from the waiter that redemption of the selected coupon is approved; and
storing an indication that the selected coupon has been redeemed.

9. The method according to claim 1, further comprising:
storing the discount coupons by the control server in an account for the customer;
determining that the customer has redeemed one of the discount coupons or the discount coupon has expired; and
removing the redeemed or expired discount coupon from the customer's account.

10. The method according to claim 1, further comprising:
storing the discount coupons by the control server in an account for the customer;
determining that the customer has transferred one of the discount coupons to another customer; and
removing the transferred discount coupon from the customer's account.

11. A system for providing discount coupons to a customer in a business establishment, the system comprising:
a control server associated with the business establishment; and
a wireless communication link for communicating between the control server and a mobile telecomputing device of the customer;
wherein the control server is configured to:
provide at least one virtual service-request button on a display of the customer's mobile telecomputing device, wherein pressing the at least one virtual service-request button enables the customer to request services from the business establishment utilizing the customer's mobile telecomputing device; and
push the discount coupons to the customer's mobile telecomputing device for display thereon.

12. The system according to claim 11, wherein the business establishment is a restaurant, and the control server is configured to provide a virtual service-request button on the display that enables the customer to utilize the mobile telecomputing device to request service from a waiter.

13. The system according to claim 12, wherein the control server is configured to proactively push the coupons to the mobile telecomputing device when the customer registers with the server.

14. The system according to claim 12, wherein the control server is configured to proactively push the coupons to the mobile telecomputing device when the waiter requests the coupon.

15. The system according to claim 12, wherein the control server is configured to push the coupons to the mobile telecomputing device in accordance with restaurant instructions.

16. The system according to claim 12, wherein the control server is further configured to provide a page for display on the mobile telecomputing device that includes virtual buttons for requesting or redeeming the coupons.

17. The system according to claim 16, wherein the control server is further configured to:
detect that the customer has pressed the button for requesting coupons;
send to the mobile telecomputing device, a list of available coupons page for the restaurant;
detect that the customer has selected an available coupon; and
store the selected coupon in an account for the customer.

18. The system according to claim 17, wherein the control server is further configured to:
detect that the customer has pressed the button for redeeming coupons;
notify the waiter that the customer desires to redeem the selected coupon stored in the customer's account;
receive an indication from the waiter that redemption of the selected coupon is approved; and
store an indication that the selected coupon has been redeemed.

19. The system according to claim 11, wherein the control server is further configured to:
store the discount coupons in an account for the customer;
determine that the customer has redeemed one of the discount coupons or the discount coupon has expired; and
remove the redeemed or expired discount coupon from the customer's account.

20. The system according to claim 11, wherein the control server is further configured to:
store the discount coupons in an account for the customer;
determine that the customer has transferred one of the discount coupons to another customer; and
remove the transferred discount coupon from the customer's account.
